(19) United States
(12) Patent Application Publication
(10) Pub. No.: US 2004/0237632 A1
(43) Pub. Date: Dec. 2, 2004

(54) Pipe joint safety inspection device

(76) Inventor: Rene Van Keeken, Mooroolbark Victoria (AU)

Correspondence Address: DENNISON, SCHULTZ, DOUGHERTY & MACDONALD, 1727 KING STREET, SUITE 105, ALEXANDRIA, VA, 22314, US

(21) Appl. No.: 10/486,927

(22) PCT Filed: Aug. 28, 2002
(86) PCT No.: PCT/AU02/01172

(30) Foreign Application Priority Data
Aug. 30, 2001 (AU) PR7375
Nov. 9, 2001 (AU) PR8785

(51) Int. Cl. G01M 19/00; G01M 3/02; F16L 55/00

(52) U.S. Cl. 73/46; 285/93; 73/865.9

(57) ABSTRACT

An inspection device for use on joint zones of piping (4) and the like where the joint zone (2) includes a joint interface (3a), the device including a housing (1) adapted for fitting over the joint interface so as to form a substantial seal bridging the joint interface. The housing is adapted to allow visual or other inspection of the joint interface.

### INTRODUCTION TO THE INVENTION

This invention relates to joints in the connecting lengths of piping and the like and in particular to such joints which incorporate a flange based connection of adjacent pipe sections and the like. The invention provides a security and safety enhancing inspection device adapted for retro or dedicated fitting to the joint region of piping joints including welded, crimped, soldered, glued and flanged joints.

### BACKGROUND TO THE INVENTION

The Petro chemical industry in particular, but in common with many (often chemical and related industries), rely on extensive piping systems to conduit fluids including liquids and gases around the plants involved in such industries. Similar piping systems are used to transport fluids and liquids to and from such plants and for general transport and shipping purposes.

Often the liquids and gasses in question can be highly hazardous products which must be handled with due care within and outside the plant.

Such piping systems generally comprise a plurality of pipe lengths joined together by flanges or other linkage or joining means. Flange joints are a common joining means and are usually held together by a combination of mechanical systems, including bolts or clips which secure the mating flanges together; along with suitable gasket means to ensure a leak proof joint. Flange joints not only serve as connecting points for pipe sections (and other associated apparatus, valves, gauges etc), but also serve as fluid isolation points during routine plant maintenance and emergency situations. However, such flange joints and other types of joints represent a weak link in any piping system and over time flange seals wear, welding can crack, crimp joints corrode, all of which and can lead to pipe leakage or complete failure. Frequently the most likely source of leakage and/or damage in a piping system can be traced to a failure or leak in a joint.

While the repair of such faulty joints can be a straight forward task, it is the ability to detect problems early whilst securing the immediate environment of a faulty joint, particularly where hazardous materials are involved, that can mean the difference between a straight forward task or a major problem with the potential to expose personnel to danger.

In order to address these types of issues certain devices have been developed to indicate leakage in a pipe joint in addition to protecting maintenance workers during inspection and repair of such joints. One such device resembles a bandage which is particularly adapted for wrapping about a flange joint in an endeavour to indicate leakage via a litmus paper or moisture detection paper insert. However, the application of such a device to a flange joint not only conceals the joint but can make removal of the wrap dangerous in the case of a failed or leaking joint. Furthermore, such devices fail to provide any true indication to maintenance personnel of the type of damage occurring in a joint, the nature of any leak, the amount and pressure of any leak and the degree of hazard associated with the leak. Maintenance staff have to routinely unwrap the heavy “bandage” material from the flange joints so as to inspect for leakage and/or damage, and are often potentially exposed to corrosive, hot, carcinogenic or otherwise hazardous materials. In addition, the crude nature of such “bandages” precludes the early detection of flange seal problems, thereby increasing the incidence of costly plant shutdowns or the risk of explosion. Furthermore, such devices tend to provide a semi-sealed and potentially corrosive environment where flange bolts tend to rust and deteriorate out of notice. Whilst such products are primarily intended for use on flange joints, they can be applied to other joint types, but suffer the same disadvantages.

The ability to address all or some of the above deficiencies in the maintenance of piping systems would greatly enhance safety and productivity in a broad range of industries particularly the Petro Chemical Industries.

### OBJECT AND STATEMENT OF THE INVENTION

One object of the invention is to provide an improved pipe joint inspection device.

In one aspect the invention provides an inspection device for use on the joint zones of piping, piping accessories and other conduting means, where said joint zones include a joint interface, said device comprising a housing adapted for fitting over said interface so as to form a substantial seal bridging said joint interface wherein said housing is adapted to allow inspection of said joint whilst fitted thereto.

In another aspect the invention provides an inspection device for use on the joint zones of piping, piping accessories and other conduiting means where said joint zones include a flange interface, said device comprising a housing adapted for fitting to the rim region of said flange, so as to form a substantial seal bridging said flange interface wherein said housing is adapted to allow visual inspection of said joint.

The housing region of the device may include an inspection chamber bridging the flange interface which occurs at the region where two flanges join. The flanges may form the terminal regions of adjoining sections of piping or may be incorporated in valves or any other form of accessory associated with such piping.

The inspection chamber may be transparent or the visual transparency may extend to the whole of the housing. The visual transparency may be in the form of completely clear transparency or may include a range of filters including tints and colours for specific purposes including ultra-violet protection etc.

The housing of the device may include an inner seat region adapted to substantially conform to the rim shape of the flange component of said joint zone. In most cases, the rim shape of the flange will be circular, however, any shape of flange or pipe joint can be accommodated by the device of the invention with confirmational shaping of the inner seat region.

The housing region may include dual parallel seat regions formed either side of the inspection chamber which are adapted to bridge the flange interface and allow the device to fit snugly onto the respective abutting flanges.

The seat regions may be provided with sealing means which can take a variety of forms depending on the application to which the device will be applied. The sealing means will generally be a compliant seal adapted to sit snugly onto the rim region of the flange, such that when the device is closed onto the flange region, the sealing means will take up any variations or irregularities in the circumference of the flange and serve to substantially seal the flange joint.

The housing component of the inspection device may be formed in two or more parts, such that the device can be assembled by way of a retro-fitting action onto existing flange joints by drawing or folding the device over an existing flange joint. The housing is most preferably formed in two substantially identical halves which are adapted to co-engage with each other, thereby facilitating installation around a joint zone. Each of the housing components may be provided with a hinge region at a first end thereof, which provides for the coupling of the two halves, which can take the form of a hinge joint, with the provision of a pivot pin. The second end of the housing parts may be provided with a locking means which can include an over-centre fast snap lock fitting requiring no tools for assembly or removal.

The inspection device may take the form of a generally torus shaped housing, forming a compact and robust addition to the flange joints of existing piping whilst minimising additional bulk to such piping systems.

The housing may, alternatively, be formed from a single piece; where the housing is compliant and adapted to be bent around a joint zone so as to conform to the joint shape. The single piece housing may include all the features of the housing described so far and include a locking means adapted to fit the device to a joint zone. In this alternative embodiment the device can be applied to a range of joint interfaces including flange joints. When applied to a flange joint, the housing region of the inspection device may include an inner seat region which is adapted to substantially conform to the outer edge of the flange. The inner seat may include an inwardly projecting ring clip adapted to engage a circumferential channel formed in the outer edge of said flange. This form of fitting of the device provides an alternative to the previously described embodiments where the device fits to a dedicated channel formed in the edge of the flange in contrast to the device sitting on top of flange rim.

The inspection device of the invention may further include a porting means which can be fitted to the housing. The port means is adapted for communicating between the interior and exterior of the inspection chamber of the device and may include a valve fitted to the housing so as to allow the port to be opened and closed, giving access to the interior of the chamber without having to release the whole device. The port means may be fitted with sensing or detection means which can be adapted to remotely sense leaks in the joint interface. The sensing means may be selected from any one or a combination of chemical, electrical or mechanical detection means in accordance with the requirements and contents of the piping system. Such sensing means may also include any detection means capable of generating a visual, audible or readable signal. In addition, the port means may be fitted with an automatic early leak warning system so as to provide an automated alarm for early and immediate detection of leaks in joint zones.

In another aspect the invention provides a flange fitted with an inspection device as previously described. The flange may have the inspection device fitted to the rim region of the flange, with the inspection device comprising a housing means fitted to the circumference of the flange rim and extending therefrom in the general radial direction of the flange. The housing may be adapted to cooperate with the mating flange inspection device to form a visually transparent inspection chamber, bridging the interface between said mating flanges. The housing may include a circumferential seat adapted to abut the corresponding seat on a mating flange. The seat regions may be sized and configured to abut under compression as the mating flanges are drawn together, but before the flanges are finally tightened.

### DETAILED DESCRIPTION OF THE INVENTION

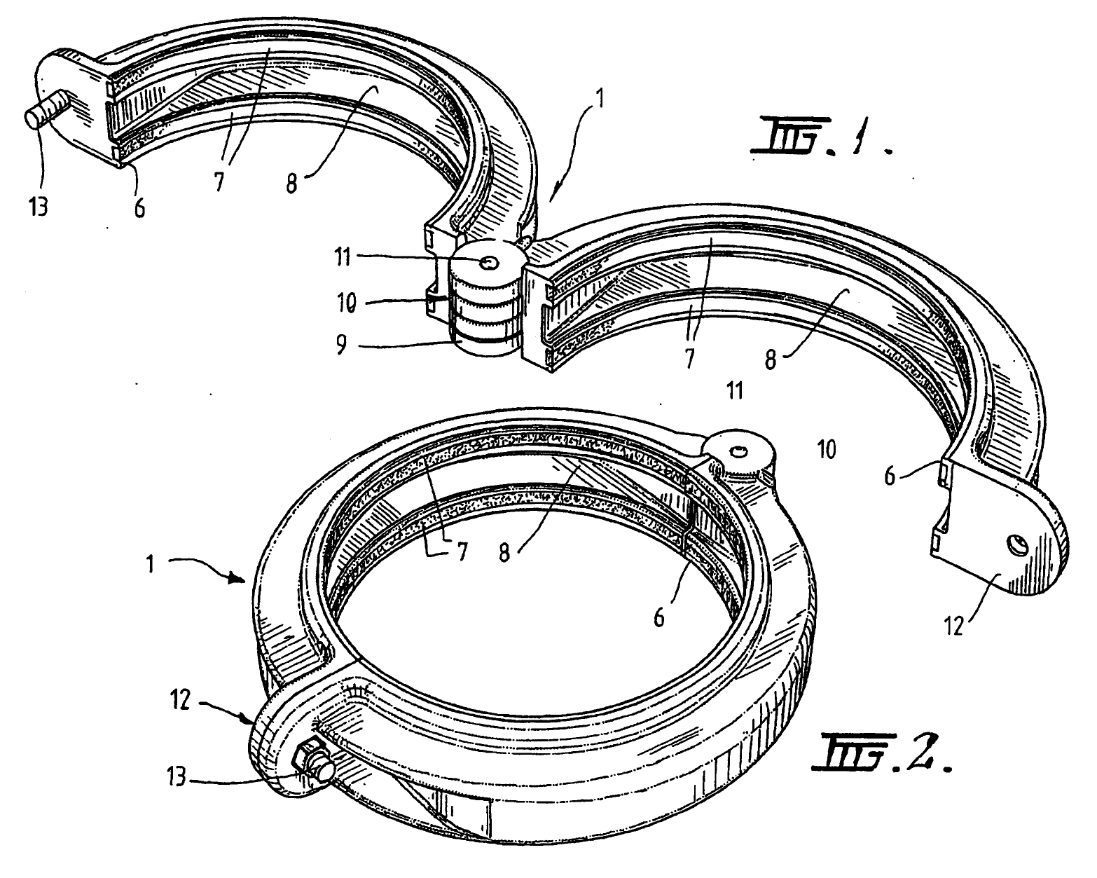

The invention will now be more fully described with reference to a first embodiment of the invention as shown in FIGS. 1 to 5 where:

FIG. 1 shows a view of the open inspection device.

FIG. 2 shows a view of the closed inspection device.

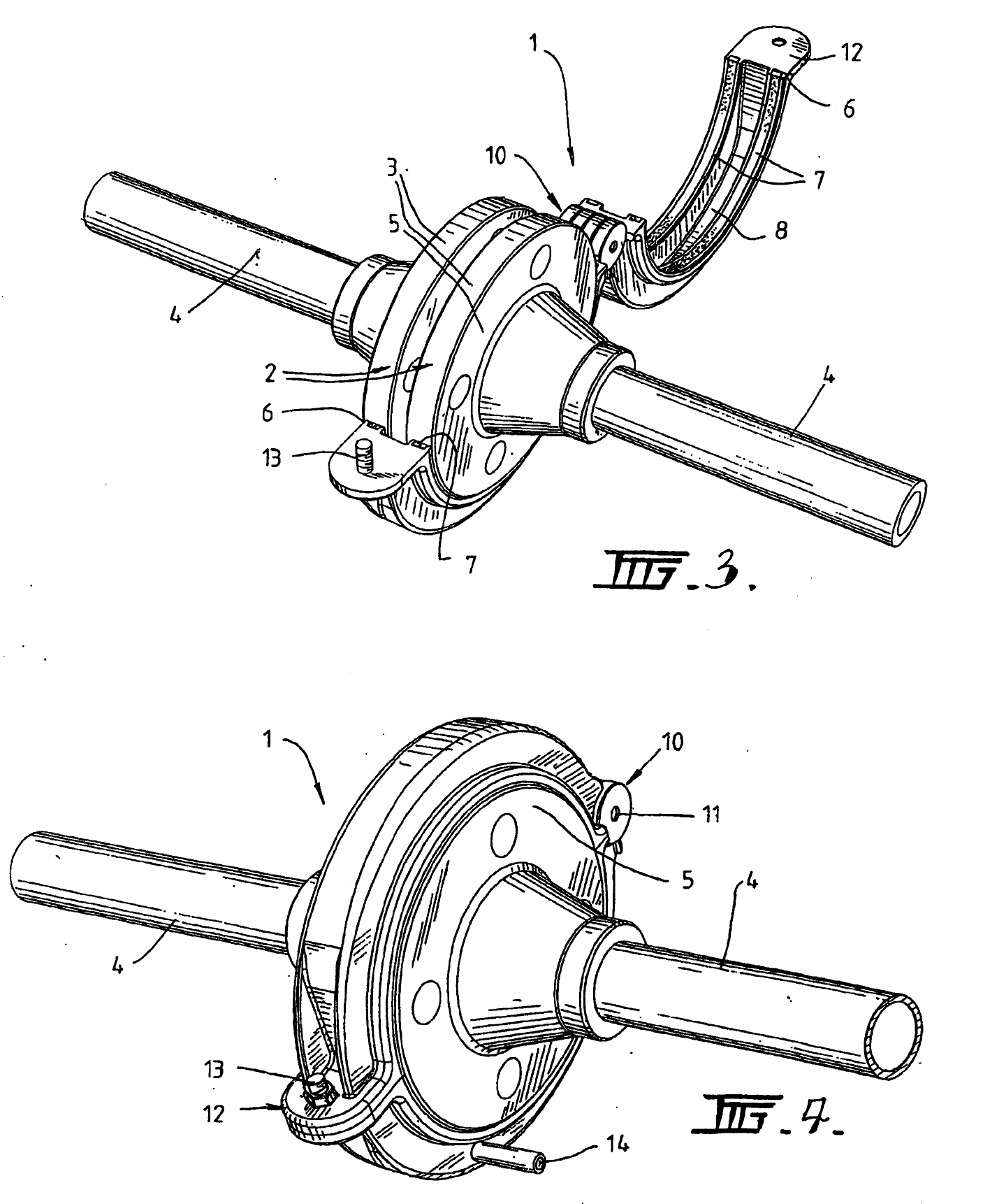

FIG. 3 shows a view of the open device being fitted to a pipe flange joint.

FIG. 4 shows a view of the closed device as fitted to a pipe flange joint.

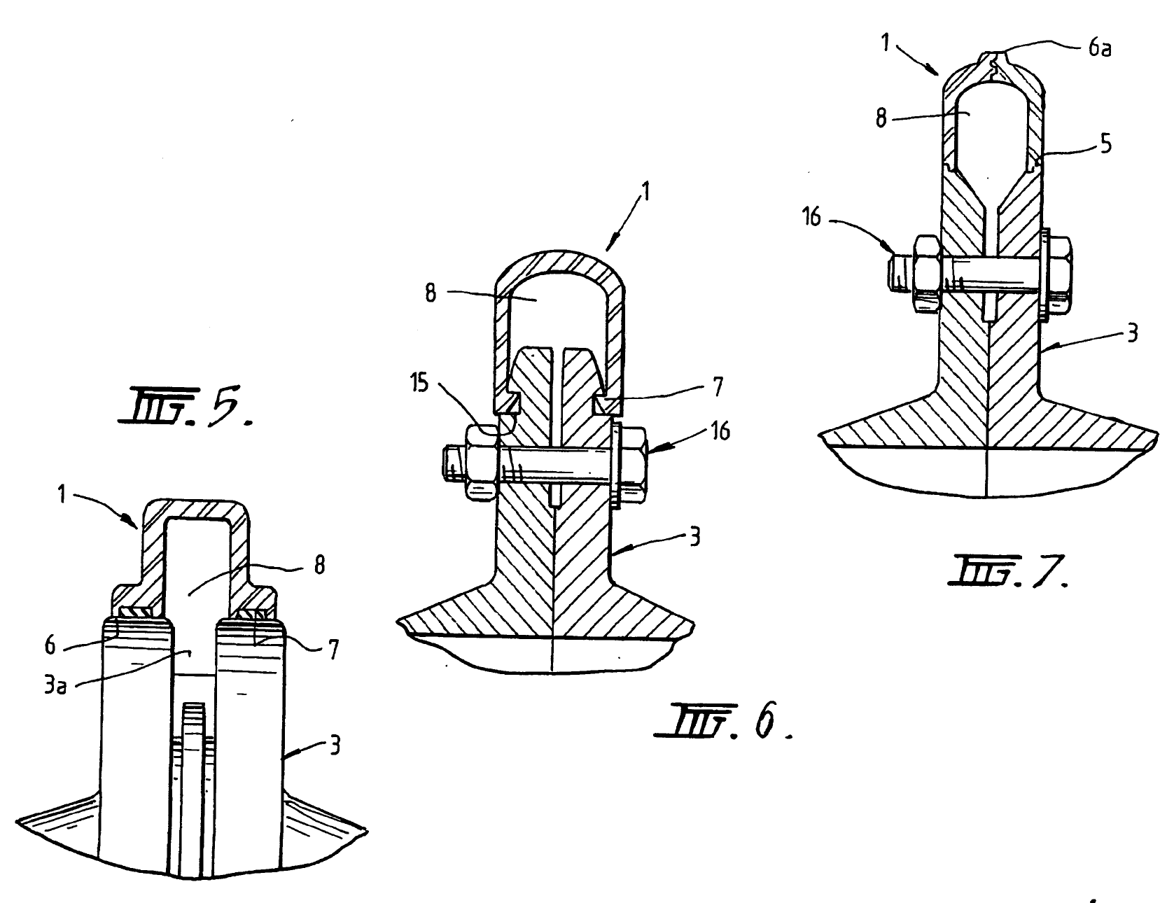

FIG. 5 shows a cross section view of the device fitted to a pipe flange joint.

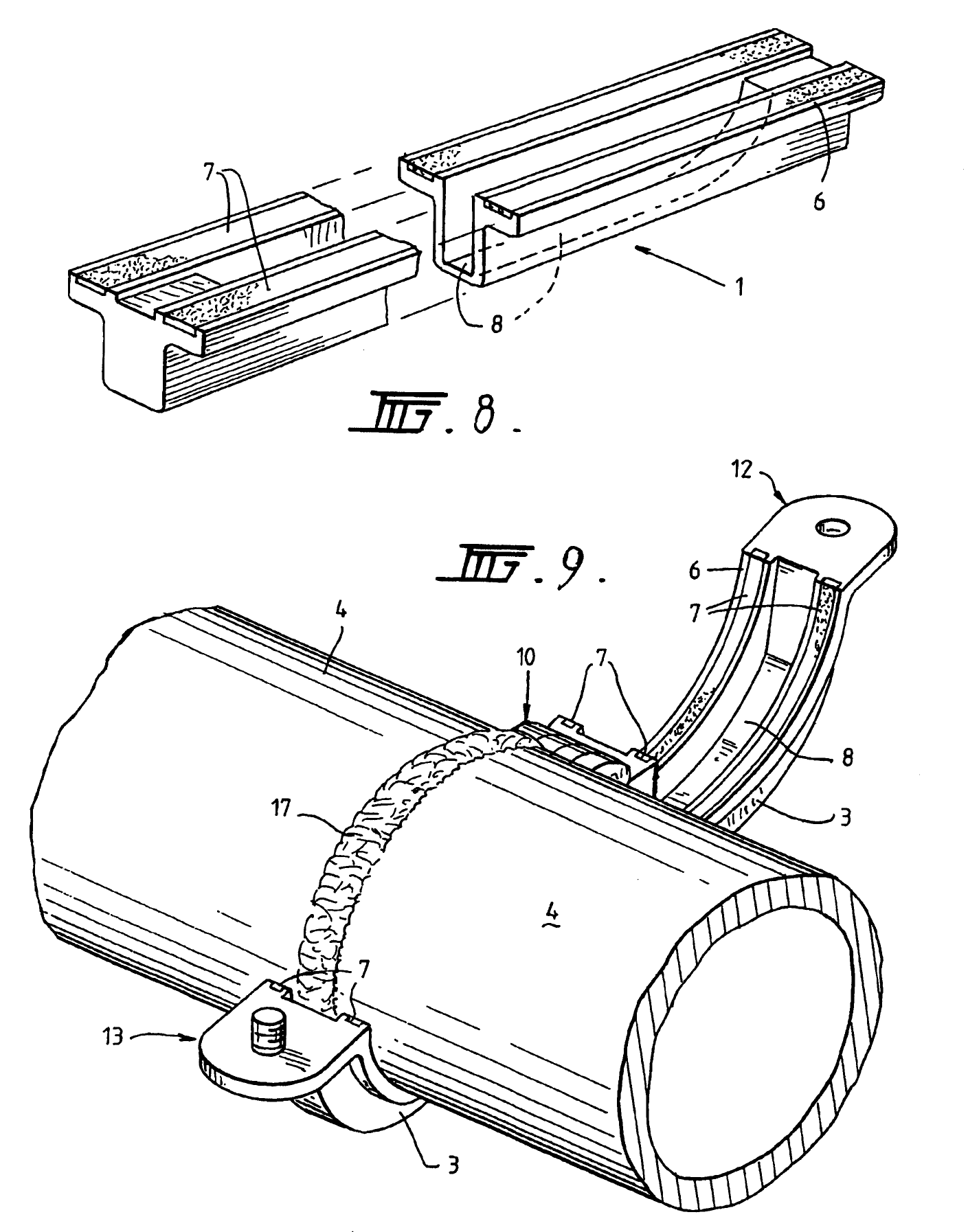

A second embodiment of the invention is shown in FIGS. 6 and 7 where:

FIG. 6 shows a cross section view of the device adapted to seal at or near the joint interface on the side of the flanges.

FIG. 7 shows the device (and part of the pipe) where the device is formed as an integral part of the pipe flange region.

FIG. 8 shows the device as a one piece flexible housing.

A third embodiment of the invention is shown in FIG. 9, where:

FIG. 9 shows the device configured for application to a weld joint in a pipe.

### EXAMPLE ONE

The device of the invention per se is shown in FIGS. 1 and 2, with FIG. 1 showing the device of the invention in its open configuration and FIG. 2 showing the device in its closed configuration. The application of the device is readily seen with reference to FIGS. 3 and 4 where the device of the invention is shown as applied to the joint zone of two abutting pipe flanges.

The inspection device of the invention is a safety accessory which is adapted for retro-fitting and use on a wide range of industrial, scientific and commercial piping and conduiting systems and is ideally suited for use and application to all joints incorporating flange fittings throughout the piping system of any plant. The purpose of the device of the invention is to provide a safety capsule for encasing or enclosing the flange region of such a joint in a manner which allows direct visual and/or instrumental inspection of the joint without exposing personnel to danger. The device is not intended as a pressure seal and does not substitute for the normal operation and sealing functions of a flange joint. The safety device is provided as a means of overlaying the flange interface so as to provide a sealed inspection chamber for the joint zone.

Example 1 of the invention shows the inspection device as a retro-fittable unit which provides for ready and immediate visual inspection of a flange joint without having to expose personnel to any leaks, sprays or explosions that may occur in a deteriorating flange joint or in a joint undergoing maintenance. Referring to FIGS. 3 and 4, the device comprises a substantially rigid two-part housing 1 where both halves of the housing are substantially identical in configuration and are sized and configured to be drawn together so as to snugly wrap around and conform to the rim region 2 of two abutting or opposing flanges 3 of adjoining pipe regions 4. The device of the invention is applicable to any situation where two flanges 3 abut together, including situations where a valve or other device has a flange incorporated therewith for joining to a piping system. The housing takes the form of a generally torus shaped construction which is adapted for snug and compact cooperation around the rim face 5 of two opposing flanges. The housing is provided with dual seat regions 6 formed in parallel where each respective seat region is provided with a compliant seal 7 such that the housing forms a snug and compliant fitting around the rim region and rim face 5 of the opposing flanges 3. In between the two parallel seat regions 6 is provided an inspection chamber 8 which is configured to bridge the interface 3a between opposing flanges 3. The inspection chamber is normally visually transparent such that when fitted to the joint region, provides a ready means of inspecting the joint region without personnel being exposed to potential leaks or spray from the joint. In addition to the inspection chamber being made of visually transparent material, the whole of the housing 1 can also be made of visually transparent material with the housing being made of suitably resistant materials dependent on the type of application intended. Such materials may include transparent plastic materials resistant to corrosive chemicals or gasses including potentially explosive or flammable fluids and biologically hazardous materials. The device of the invention is not intended as a pressure vessel and accordingly, the degree of sealing provided by the seal 7 can be varied to form a degree of sealing from partial sealing to an airtight seal and optionally include pressure relief valves or blow-out seals as required.

The device of the invention is preferably manufactured as two identical mating pairs where a first end thereof 9 is provided with a hingable construction 10 adapted to cooperate with a mating device and a hinge pin 11. Alternatively, the hingable construction 10 may form an interconnecting means including an integral hinge pin 11 thereby minimising the number of components. The second end of the device 12 incorporates a locking means 13 which can take the form of an over-centre snap type lock or clip to allow ready closing of the mating pair and equally provided for the ready removal of the device when required.

FIG. 4 shows the device of the invention as installed to a joint zone where both halves of the device in the form of housings 1 have been folded over around the hinge 11 and secured by way of a bolt lock 13. The bolt lock can be substituted with over-centre or snap lock fittings as required. The two housing halves can be seen to neatly fit around the rim face 5 of the flange 3 with the inspection chamber 8 providing a continuous substantially sealed chamber fully surrounding the flange interface.

The inspection device may be provided with a porting means 14 which is adapted to communicate between the interior and exterior of the inspection chamber 8. The port may be provided with a valve so as to allow a means of accessing the inspection chamber in a controlled manner without having to release the inspection device. The port could also be provided with a pressure relief valve, drain, tap or other access means allowing any contents of the inspection chamber to be moved away from the joint zone completely to a remote location. A blow out seal may also be provided. The porting can be provided as an integral part of the device or can be retrofitted by drilling through the housing 1 of the device which can be tapped to accommodate non-standard fittings and accessories.

Referring now to FIG. 5, the compact nature of the inspection device of the invention can be readily seen in the cross-sectional view where the housing 1 can be seen to sit snugly and unobtrusively on the rim face 5 of the flanges 3 associated with the pipe 4. The housing is provided with a seal 7 on the inner region thereof which sits around the rim 5. The housing rises above the flange interface 3a to provide an inspection chamber 8 formed as a bridge over the flange interface. The compact nature of the inspection device mininuses space requirements and potential interference with other plant operations whilst at the same time, providing a high level of protection and ready access to the piping systems including the flanges 3 during plant running and maintenance operations.

### EXAMPLE TWO

An alternative embodiment of the invention will now be shown with reference to FIG. 6 where the housing 1 is provided with the seal region 7 adapted for engaging with a circumferential channel 15 formed around the outer edge of a flange 3. This embodiment of the inspection device of the invention is fitted by way of drawing the housing over the rim region of the flange such that the seal comprising an inwardly projecting ring clip is drawn over the rim face 5 and down so as to engage the channel 15 formed at the outer edge of the flange. The fitting of this embodiment of the invention allows ready access to the flange bolts 16 and provides an alternative embodiment of the invention. This embodiment of the invention can also incorporate a single piece housing which may be formed and fitted in a manner similar to a vehicle wheel tyre.

### EXAMPLE 3

Referring now to FIG. 7, the inspection device of the invention can take the form of an integral unit formed as part of a pipe joint interface or flange design. In this embodiment of the invention the housing 1 is formed as an extension of the flange rim face 5 which is extended radially beyond the normal region of the flange. The housing is provided with a circumferential seat 6a and a suitable seal such that when the mating flanges are drawn together, the housing halves are brought together in sealed engagement so as to provide an additional and accessory seal for such flange joint zones. The housing and inspection device is adapted for form a compliant fit and is preferably configured to mate together prior to full engagement of the flanges 3 so as to ensure snug and complete sealing prior to and during full take up of the opposing flanges 3. In this manner, the inspection device in this embodiment provides many of the advantages of the retro-fittable unit detailed in the previous embodiments but can be provided as an integral design component of flange production providing a compact, economical and functional value added accessory to current plumbing practises and eliminating the need for retrofitting of after market safety inspection devices.

### EXAMPLE 4

Referring now to FIG. 8, the inspection device of the invention can take the form of a one piece housing 1 incorporating the inspection chamber 8 and dual seat region 6 and seals 7 in an analogous manner to the previous embodiments of the device. However, the one piece configuration of the device as shown in this example, is formed of compliant material such that this embodiment of the device can be wrapped around virtually any shape of pipe connection or flange connection wherein the device can be cut to the appropriate length and locked in place by way of a suitable locking means formed at either end of the device. In this particular embodiment, the device can be formed by an extrusion process in various lengths such that a highly economical form of the invention can be provided in a manner where the device can be “cut to length” and applied to piping situations as required.

### EXAMPLE 5

Referring now to FIG. 9, the device of the invention is shown as applied to the joint zone 17 of the pipe 4, where the joint zone 17 is formed as a welding joint, connecting two adjacent pieces of pipe 4. This embodiment of the invention, shares virtually all the features of the previous embodiments where the dual seat region 6 and seal 7 are configured and dimensioned to bridge the welding joint 17 at the piping joint interface. The inspection chamber 8 is similarly configured to a suitable size and dimension to bridge the joint interface and once applied to the joint, serves to provide all the advantages of the previously described embodiments where the inspection device provides a ready means of safely inspecting such welded joint zones which can become subject to corrosion and leaks in a similar manner to flange joints and other pipe joining means.

In use, the device of the invention would ideally be applied to every pipe joint throughout the piping or conduiting systems of a given industrial site. Industrial sites of particular interest would be Petro Chemical plants, which routinely deal with hazardous materials. For a given plant with many such joints, the device of the invention could be retrofitted to each of those joints and would be made in a variety of sizes dependent on the dimensions of the joints to be protected. When a joint has failed and exposed the device to contamination or leakage, the device may be removed, once suitable inspections and determination of the problem have been undertaken. The device may be disposed of and replaced with a fresh device to ensure the safety and specifications of the device are maintained. Alternatively, the device can be fitted with fresh seals and recommissioned if appropriate.

In the case of an inspection device formed integrally with the pipe joint in the event of a failure, suitable replacement housings and devices could be made available such that it would not be necessary to replace the whole flange joint in the event of a leakage, providing of course, the nature of the leakage and damage was not the result of a failure of the joint per se.

The device of the invention in any of the embodiments detailed herein provides a selection of safety measures for protecting pipe joints by way of a device fitted in close proximity to the joint interface. The device of the invention can either be fitted permanently or can be adapted for removal and may optionally be reused with application of fresh seals and fixtures as appropriate.

In addition to the advantages of the invention as described above, the inspection device, when applied to the pipe fittings throughout an industrial setting, offers not only comfort and safety for maintenance personnel but also expands the options for maintenance procedures beyond those normally available in current situations. For example, with the inspection device of the invention fitted to pipe joints, it is possible to inspect for slow or intermittent leaks which will show up as the leaking gas or liquid is accumulated in the bottom of the inspection chamber. In addition, when a joint is required to be dismantled, the inspection device of the invention provides a safe environment for checking that the fluid pressure in the pipe region has been turned off prior to dismantling of the flange joint. In this case, the flange could be “cracked” or loosened slowly and, in the event that the pipe has not been fully disconnected, any preliminary leaks or spray will be immediately detected and confined within the safety of the inspection chamber and the flange can be re-tightened and the pipes be suitably disconnected before further maintenance is carried out. The inspection device of the invention allows a flange to be “cracked” with the device in place such that any residual pressure in the line can be detected, the joint re-tightened and the line purged of pressure.

Most particularly, the device of the invention provides protection against “spraying” where a maintenance operator attending the repair or inspection of a pipe joint, particularly a flange pipe joint, will begin to undo the flange joint carefully in order to avoid any unexpected pressure build up or spraying as the joint is cracked. However, such operations are fraut with danger and hazards due to the inevitable occurrence of such spraying accidents in situation where a joint is faulty. As the flange joint is carefully opened, it releases the piping contents in the form of a pressure release and spraying of the contents which exposes the maintenance personnel to extreme danger. The device of the invention virtually eliminates this hazard as the flange joint can be confidently released by maintenance personnel knowing that any such spray or uncontrolled leakage of the piping contents will be readily contained by the inspection chamber of the device thereby allowing the flange joint to be re-tightened or suitable maintenance work to be carried out in a safe and controlled working environment.

Alternatively, the device of the invention can act as a purging device with the use of suitable pressure relief valves which can direct or expel material away from the flange or site by means of suitable conduits.

The inspection device of the invention can be provided with a range of accessories including bolt-head shields, UV guards, vents, taps, knock-out tabs for accessory fitting and screw thread bosses. The device can be adapted for drilling and tapping to accommodate non-standard fittings and accessories including gas and liquid detectors and indicating devices including litmus paper or special coatings adapted to change a colour in the presence of leaking gasses or liquids. Unlike currently available protective devices, the inspection device of the invention can remain in place during flange and pipeline servicing and maintenance. In addition the device can receive and cooperate with a vast range of accessories currently on the market which, until now, were unable to be ready used in conjunction with such joint zones.

The inspection device of the invention can be manufactured in a range of materials including materials allowing for visual inspection where a housing can be manufactured of clear or transparent materials or may also include tinted or coloured filters in accordance with the particular requirements envisaged for the device. For example, the housing could be manufactured of UV opaque material or of particular filters designed to enhance the visual transparency in relation to the particular products being conduited through the flange joint. The device of the invention can be injection moulded using single or multiple material moulding techniques. The moulding may incorporate two or more different colours for the seal and housing components. Alternatively, the product can be over moulded involving a two stage manufacturing process, extruded, thermo formed, blow moulded or any other suitable manufacturing technique can be assembled post-production in accordance with the specific requirements. The method of manufacture can include automated seal fitting or assembly can be accomplished manually.

The device of the invention allows the fitting of detection and sensor devices thereby facilitating remote monitoring of plant and equipment in a highly precise and dedicated manner allowing virtual access and monitoring of every pipe joint in a given plant. The remote monitoring of pipe joints can be particularly facilitated by the use of tap and valve accessories to the housing region of the device which can function to conduit away from the sight of a particular pipe joint, any leakage, spraying or other environmental contaminants that may occur in the region of the pipe joint. The remote handling of such products can provide great advantages, particularly when such piping is positioned in difficult or inaccessible places within a particular environment in question. In this manner, regular, rapid and easily monitored maintenance can be accomplished, even in highly complex, inaccessible and dangerous industrial situations.

The device of the invention finds application in virtually all industrial situations where piping of gasses and liquids is undertaken including the petrol chemical industry, waste treatment plants, food industries, medical industries, hospitals etc.

The device of the invention helps prolong the life of joint zones by encouraging regular and routine maintenance and ready identification of problems and virtually eliminates the exposure of maintenance crew and personnel to a danger that is currently regarded and accepted as a high risk industry.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. An inspection device for use on the joint zones of piping, piping accessories and other conduiting means, where said joint zones include a joint interface, said device comprising a housing adapted for fitting over said interface so as to form a substantial seal bridging said joint interface wherein said housing is adapted to allow inspection of said joint whilst fitted thereto.

2. An inspection device according to claim 1 wherein said housing is adapted for fitting over and in close proximity to said interface.

3. An inspection device according to claim 1 wherein said joint zones include a flange interface, said device comprising a housing adapted for fitting to the rim region of said flange so as to form a substantial seal bridging said flange interface wherein said housing is adapted to allow inspection of said joint whilst fitted thereto.

4. An inspection device according to claim 3 where said housing includes an inspection chamber bridging said flange interface.

5. An inspection device according to claim 4 wherein said inspection chamber is visually transparent.

6. An inspection device according to claim 3 wherein said housing includes an inner seat region adapted to substantially conform to the rim shape of said flange.

7. An inspection device according to claim 6 wherein said housing includes dual parallel seat regions formed either side of said inspection chamber and being adapted to bridge said flange interface.

8. An inspection device according to claim 6 wherein said seat regions are provided with sealing means.

9. An inspection device according to claim 8 wherein said sealing means are adapted to snugly abut the rim face of said flange.

10. An inspection device according to claim 1 wherein said housing is formed in two or more parts adapted for retro-fitting over an existing joint zone.

11. An inspection device according to claim 10 wherein said housing is formed in two substantially identical halves adapted for co-engagement and installation over a joint zone.

12. An inspection device according to claim 11 wherein each of said housing parts are provided with a hinge means at a first end thereof and provision for a locking means at a second end thereof.

13. An inspection device according to claim 1 wherein said housing is generally torus shaped.

14. An inspection device according to claim 1 wherein said housing is formed in one compliant piece adapted to conform to the configuration of an existing joint zone.

15. An inspection device according to claim 14 wherein said one piece housing is provided with a locking means adapted to secure said housing to said joint zone once fitted thereto.

16. An inspection device according to claim 3 wherein said housing includes an inner seat region adapted to substantially conform to the outer edge of said flange.

17. An inspection device according to claim 16 wherein said inner seat includes an inwardly projecting ring clip adapted to engage a circumferential channel formed in the outer edge of said flange.

18. An inspection device according to claim 1 further including a port means for communicating between the interior and exterior of said housing.

19. An inspection device according to claim 18 wherein said port means includes a valve fitted to said housing to allow opening or closing of said port.

20. An inspection device according to claim 1 wherein said port means is fitted with a sensing means to detect leaks in said joint interface.

21. An inspection device according to claim 20 wherein said sensing means is selected from chemical, electrical or mechanical detection means.

22. An inspection device according to claim 20 wherein said port means and/or said sensing means is fitted with an automatic and early leak warning system.

23. A flange fitted with an inspection device according to claim 1.

24. A flange having fitted to the rim region thereof an inspection device comprising a housing means fitted to the circumference of said flange rim region and extending radially therefrom wherein said housing is adapted to cooperate with a mating flange inspection device to form a visually transparent inspection chamber bridging the interface between said mating flanges.

25. A flange according to claim 24 wherein said housing includes a circumferential seat adapted to abut a corresponding seat or said mating flange.

26. A flange according to claim 24 wherein said housing includes a port means for communicating between the interior and exterior of said inspection chamber.

27-28 (canceled).
